(19) United States
(12) Patent Application Publication
(10) Pub. No.: US 2017/0321871 A1
(43) Pub. Date: Nov. 9, 2017

(54) Mounting Device for Mounting Holding Rails for Lamps

(71) Applicant: ZUMTOBEL LIGHTING GMBH, Dornbirn (AT)

(72) Inventors: Martin Bader, Dornbirn (AT); Wolfgang Bechter, Hittisau (AT); Wolfgang Gadner, Horbranz (AT)

(73) Assignee: ZUMTOBEL LIGHTING GMBH, Dornbirn (AT)

(21) Appl. No.: 15/524,312

(22) PCT Filed: Dec. 11, 2015
(86) PCT No.: PCT/EP2015/079402

§ 371 Date: May 4, 2017

(30) Foreign Application Priority Data
Dec. 17, 2014 (DE) 20 2014 106 103.7

(51) Int. Cl. F21V 21/34; E04B 9/00; F21S 8/00; F21S 8/04

(52) U.S. Cl. CPC F21V 21/34; F21S 8/043; E04B 9/006; F21S 8/036

(57) ABSTRACT

The invention relates to a mounting device (1) for mounting holding rails (4a, 4b) for lamp housings to cut-outs (3) of suspended walls or ceilings, comprising a substantially rigid frame (15) and, connected thereto, a first holder (2a) for retaining a first holding rail (4a) and a second holder (2b) for retaining a second holding rail (4b), wherein the holders (2a, 2b) are designed to hold the holding rails (4a, 4b) parallel to and at a defined distance from each other. The invention further relates to a mounting system, comprising a mounting device (1) according to the invention and at least two holding rails (4a, 4b)

### FIELD OF THE INVENTION

The invention relates to a mounting device for retaining receiving rails for lamps during the installation of the receiving rails on a suspended wall or ceiling.

### BACKGROUND OF THE INVENTION

Conventionally, built-in lamps for suspended ceilings and walls are attached directly to a cut-out in the suspended ceiling or wall. For this, the drywall hanger must first prepare a cut-out, in which the electrician subsequently installs the lamp. After this, the drywall hanger must again plaster the lamp flush with the surface. This solution is complicated, not only because the two builders must interact, but because there is also a tendency of crack formation.

WO 2014/020015 A1 discloses such an installation system.

### SUMMARY OF THE INVENTION

In order to overcome the difficulties specified above, a novel mounting system for a thermally decoupled installation of lamps has been developed. The novel mounting system makes use of receiving rails, which are installed at a defined spacing on a cut-out in a suspended ceiling or wall. The receiving rails are preferably plastered in up to a plastering edge. The electrician can insert the lamps directly in the receiving rails prepared thus, without the drywall hanger having to get involved. Further subsequent work by the drywall hanger is unnecessary. Good thermal separation of the lamp from the suspended wall or ceiling is also obtained, because spacing remains between the receiving rails and the edge of the cut-out.

The installation of the receiving rails has remained complicated, however, because a precisely parallel course at a defined spacing in the correct alignment is required in order to be able to install the lamps, which may be from different manufacturers, without difficulty. So far, it has thus been necessary for the drywall hanger to install the receiving rails with great precision, and connect them to the suspended ceiling or wall. This requires a great deal of effort in terms of work time, and is prone to errors, making it impossible to later install the lamps.

The invention thus has the object of creating a mounting device that enables time-saving installation of the receiving rails.

A mounting device according to the invention for receiving rails for lamp housings on cut-outs in suspended walls or ceilings contains a substantially rigid frame, and a first receiving element connected thereto for mounting a receiving rail and a second receiving element for mounting a second receiving rail. The receiving elements are configured to keep the receiving rails parallel to one another thereby, and to keep them at a defined spacing to one another. As a result, during the installation of the receiving rails, the drywall hanger does not have to worry about the receiving rails being parallel or having the proper spacing. A very simple and quick installation of the receiving rails is thus obtained.

The receiving elements are preferably designed to retain the receiving rails individually and/or collectively in a releasable manner, preferably such that they can be released with one hand. In this manner, the installation is further simplified.

Additionally or alternatively, the receiving elements are designed to retain the receiving rails such that they can be slid longitudinally in relation to the mounting device. In this manner, the receiving rails can both be very precisely arranged longitudinally.

Additionally or alternatively, the receiving elements are designed to retain the receiving rails in a defined orientation to one another over their respective longitudinal axes. A particularly reliable alignment of the receiving rails is thus obtained.

The mounting device is preferably designed for installing substantially L-shaped receiving rails, each of which has a first leg that is to be mounted to an undersurface of the suspended ceiling, or the front surface of the suspended wall, and a second leg that engages in the cut-out and supports the lamp housing. In this case, the receiving elements are designed to retain the receiving rails such that the first legs run in one plane, and the second legs are parallel. In this manner, it is ensured that the receiving rails can be installed very easily, and the lamps can later be very easily inserted.

The receiving elements preferably have a first guide profile for receiving a first profile of the respective receiving rail, preferably for receiving the profile of the second leg of the receiving rails. The first guide profiles can be flexible or resilient, and connected to the rigid frame, in particular via resilient arms. A particularly secure retaining of the receiving rails by the mounting device is thus ensured. Furthermore, the guide profile can be readily snapped into the profile of the receiving rail.

The receiving elements preferably each have a second guide profile for receiving a second profile of the respective receiving rail, preferably for receiving a plastering edge of the receiving rail. The second guide profiles are also preferably rigid, and provided in particular as an integral part of the rigid frame, in the form of wings extending laterally from the frame. The wings can furthermore be designed such that they are flush with the receiving rails, in particular with the first legs thereof, when the receiving rails have been inserted. A further improvement of the retaining security is thus achieved. Moreover, as a result of the corresponding elements, and due to the rigid frame, predetermined spacing of two receiving rails is ensured in a simple manner. In particular, in conjunction with the preferably flexible first guide profile, the receiving rail(s) can thus be clamped between the two receiving elements in a simple manner, and thus aligned in a predetermined orientation to one another. For this, the first guide profiles and the second guide profiles are substantially opposite one another, and facing one another, in order to be able to clamp the receiving rails between them. The guide profiles are configured to serve as a guide for sliding the mounting device longitudinally, together with the corresponding elements on the part of the receiving rails.

The mounting device can furthermore have a handle for holding the mounting device, which is preferably attached to the rigid frame. According to one embodiment, this handle can be directly attached to the frame via resilient legs, or via the first guide profiles. In the latter case, it is furthermore possible to manipulate the first guide profiles by means of the handle, thus pivoting the first guide elements inward (toward one another), and thus freeing them for inserting or removing the mounting device.

The receiving elements are preferably designed to retain two respective receiving rails adjoining one another in the longitudinal direction such that they are aligned. In particular, when installing numerous adjoining receiving rails in a shared cut-out in the suspended ceiling or suspended wall, particularly high alignment precision is obtained in this manner.

The receiving elements are preferably designed to receive a receiving rail not yet installed on the suspended ceiling or suspended wall, in order to receive a receiving rail already installed on the suspended ceiling or suspended wall, and to receive a receiving rail not yet installed on the suspended ceiling or suspended wall. In this manner, the drywall hanger can choose between two different installation possibilities. With the first possibility, he first connects two receiving rails to the mounting device, and inserts the receiving rails connected in this manner in the cut-out in the suspended wall or ceiling, in order to then attach them to the suspended wall or suspended ceiling. With the second alternative, the drywall hanger first installs one of the receiving rails on the suspended wall or suspended ceiling in the region of the cut-out, and subsequently inserts the mounting device in the already installed receiving rail. Another receiving rail is subsequently inserted in the second receiving element of the mounting device. This second receiving rail can then be attached to the suspended wall or the suspended ceiling. In this manner, the installation exhibits a great deal of flexibility.

The mounting device is preferably designed as a single piece. Additionally or alternatively, the mounting device is designed as a stamped piece of sheet metal, or as a metal injection-molded part. In this manner, a particularly simple and economical production is ensured.

The mounting device according to the invention is particularly advantageous because a fitting of the second leg of the receiving rails to the edges of the respective cut-out is not necessary. A particularly good thermal separation of the receiving rails from the edges of the suspended ceiling or the border can be obtained in this manner.

A mounting system according to the invention includes a mounting device described above, and at least two receiving rails. A particularly simple installation of the mounting rails and later installation of lamps is thus ensured.

The mounting system preferably has a first mounting device, as described above, and a second mounting device, as described above, and at least two receiving rails. The first mounting device and the second mounting device are configured to retain the receiving rails simultaneously at different positions (e.g. one end of the receiving rails in each case), and to be disposed such that they can slide longitudinally along the receiving rails. In this manner, it is ensured that particularly precise alignment and positioning of the mounting rails is obtained.

### BRIEF DESCRIPTION OF THE DRAWINGS

The invention shall be described by way of example below, based on the drawings, in which advantageous exemplary embodiments of the invention are illustrated. Therein:

FIG. 1 shows a three-dimensional view of a first exemplary embodiment of the mounting device according to the invention;

FIG. 2 shows a side view of a second exemplary embodiment of the mounting device according to the invention; and

FIG. 3 shows a top view of a third exemplary embodiment of the mounting device according to the invention.

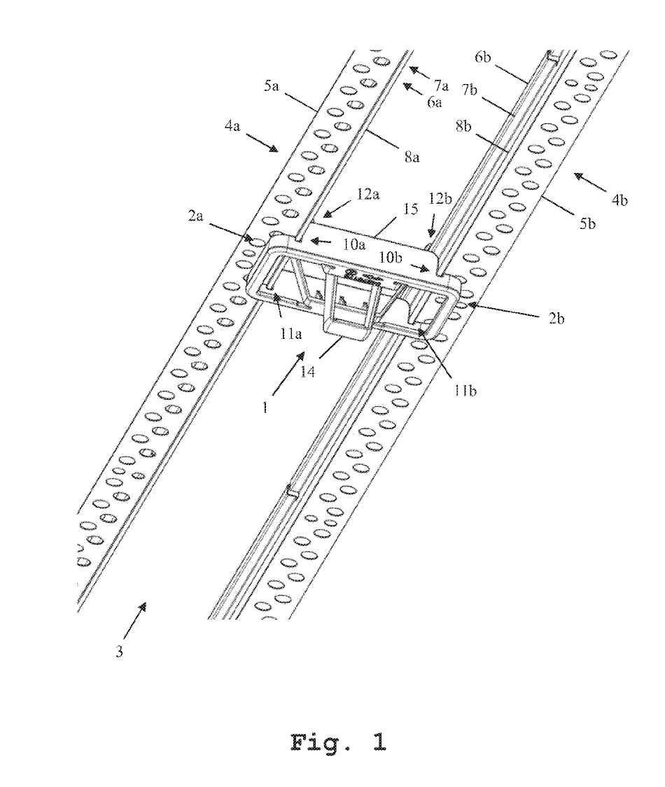

A detailed description of the construction and the functionality of different exemplary embodiments of the mounting device according to the invention shall be provided below, based on FIGS. 1-3. Not all of the identical elements shall be depicted in similar illustrations and described repeatedly.

### DETAILED DESCRIPTION

A first exemplary embodiment of the mounting device 1 for installing receiving rails 4a, 4b is depicted in FIG. 1. An installation of the receiving rails 4a, 4b on a suspended ceiling is illustrated therein. As a matter of course, an identical installation on a suspended wall is likewise possible. The mounting rails 4a, 4b are attached to the lateral edges of a cut-out 3 in the suspended ceiling, and border on the cut-out 3.

Each of the two receiving rails 4a, 4b has a first leg 5a, 5b, which is attached to the suspended ceiling, parallel thereto. Furthermore, each receiving rail 4a, 4b has a second leg 6a, 6b, which is disposed at a 90° angle to the first leg 5a, 5b, and engages in the cut-out 3. The second legs 6a, 6b are designed to support the lamp housing that is to be installed in the cut-out 3.

The receiving rails 4a, 4b furthermore have plastering edges 8a, 8b thereby, which separate the first legs 5a, 5b from the second legs 6a, 6b. The plastering edges 8a, 8b are used to plaster the receiving rails 4a, 4b flush with the undersurface of the suspended ceiling.

Furthermore, an exemplary embodiment of the mounting device 1 according to the invention is depicted in FIG. 1. The mounting device 1 has receiving elements 2a, 2b, which serve to retain the receiving rails 4a, 4b. The receiving rails 4a, 4b are retained by the receiving elements 2a, 2b of the mounting device 1, parallel to one another and at a defined spacing. It is thus easily possible to install the receiving rails 4a, 4b on the edges of the cut-out 3, while they are held by the mounting device 1 in the correct position and orientation.

In particular, the receiving rails 4a, 4b are held by the receiving elements in a defined orientation to one another about their respective longitudinal axes. I.e., the receiving rails 4a, 4b are retained such that their respective second legs 6a, 6b engage in the cut-out 3, while their respective first legs 5a, 5b lie in a plane parallel to the undersurface of the suspended ceiling.

Preferably, the receiving rails 4a, 4b can be individually or collectively retained by the receiving elements 2a, 2b such that they can be released, preferably with one hand. In this manner, the installer can very easily attach the receiving rails 4a, 4b to the mounting device 1 individually or collectively, and later separate them from the mounting device 1. In particular, because they can be released with one hand, the work sequence is significantly simplified thereby, because the installer can thus use tools with his second hand.

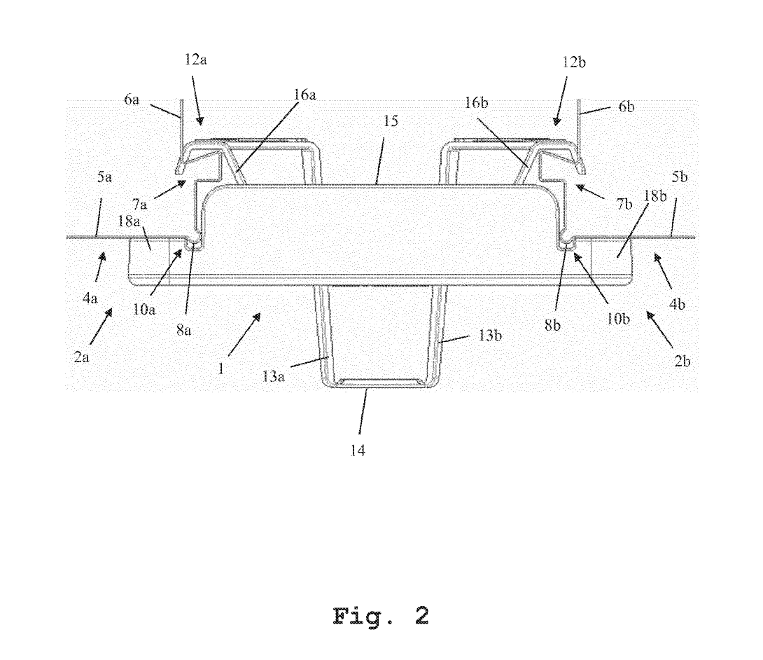

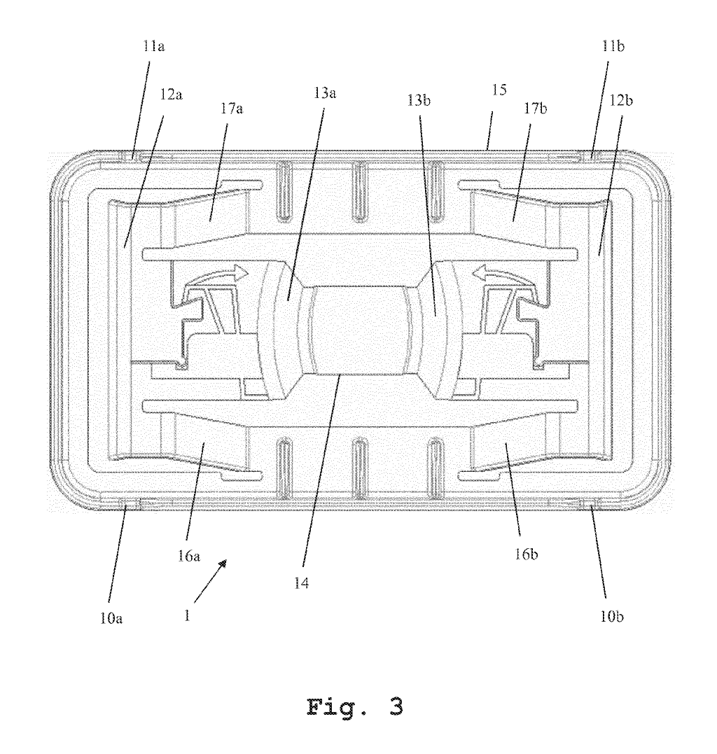

The receiving elements 2a, 2b each have a first guide profile 12a, 12b, which is designed to engage in the profiles of the second legs 6a, 6b of the receiving rails 4a, 4b, and thus to retain them. The first guide profiles 12a, 12b are flexible or resilient, in that they are attached via resilient arms 16a, 16b, 17a, 17b (see FIG. 3) to the rigid frame 15 of the mounting device 1. Furthermore, the receiving elements 2a, 2b have second guide profiles 10a, 10b, 11a, 11b, which serve to receive the plastering edges 8a, 8b of the receiving rails 4a, 4b. The second guide profiles 10a, 10b, 11a, 11b are preferably rigid, in that they are provided as an integral part of the rigid frame 15, preferably in wings 18a, 18b extending laterally away from the frame 15 (see FIG. 2). The wings 18a, 18b are designed such that they are flush with the receiving rails 4a, 4b, or the first legs 5a, 5b thereof, when the receiving rails 4a, 4b have been inserted. There are two second guide profiles 10a, 10b, 11a, 11b in each of the receiving elements 2a, 2b in the exemplary embodiment depicted here. All of the guide profiles 10a, 10b, 11a, 11b 12a, 12b are configured to serve as guides for sliding the mounting device 1 longitudinally in the receiving rails 4a, 4b, together with the corresponding elements on the part of the receiving rails 4a, 4b. The first guide profiles 12a, 12b are substantially opposite the second guide profiles 10a, 10b, 11a, 11b, and face one another. The receiving rails 4a, 4b can thus be clamped between the guide profiles 10a, 10b, 11a, 11b, 12a, 12b.

A very secure, readily releasable and substantially stable retaining of the receiving rails 4a, 4b during the installation process is ensured by the retaining of the receiving rails 4a, 4b by the guide profiles 10a, 10b, 11a, 11b, 12a, 12b of the receiving elements 2a, 2b of the mounting device 1.

If a particularly long cut-out is to be provided with receiving rails 4a, 4b using the mounting device according to the invention, it may be necessary to connect numerous receiving rails 4a, 4b to one another in the longitudinal direction. In this case, the mounting device 1 is designed to retain two directly adjoining receiving rails with each receiving element 2a, 2b, thus retaining a total of four receiving rails 4a, 4b. In this manner, precise alignment at the transition of adjoining receiving rails 4a, 4b is ensured.

The installer has numerous options for installing the receiving rails 4a, 4b. On one hand, he can connect two not yet installed receiving rails 4a, 4b to the receiving elements 2a, 2b of the mounting device 1, and place the receiving rails 4a, 4b connected in this manner collectively in the cut-out 3. He can then attach both receiving rails simultaneously to the edges of the cut-out 3.

Alternatively, the installer can connect one receiving rail 4a, 4b to an edge of the cut-out 3, and subsequently connect the already installed receiving rail 4a, 4b to the mounting device 1, and to a not yet installed receiving rail 4a, 4b by means of the mounting device.

The mounting device 1 is preferably designed to be operated with one hand. For this, the mounting device 1 has a handle 14, which is preferably connected to the frame 15 and is used to hold the mounting device 1, and thus the receiving rails 4a, 4b connected thereto. In a preferred embodiment, shown in the Figures, the handle 14 is connected to the frame 15 by means of resilient legs 13a, 13b via the first guide profiles 12a, 12b. In this case, the handle 14 can preferably also serve to release and attach the receiving rails 4a, 4b from and to the receiving elements 2a, 2b. By pressing the respective two legs 13a, 13b of the handle 14 connected to one of the opposite first legs 12a, 12b together, the guide profiles 12a, 12b are pushed away from the profiles 7a, 7b of the second legs 6a, 6b of the receiving rails 4a, 4b, and exposed toward the second guide profiles 10a, 10b, 11a, 11b, by means of which the receiving rails 4a, 4b no longer sit securely in the receiving elements 2a, 2b.

Preferably, the receiving rails 4a, 4b can be slid longitudinally in the receiving elements 2a, 2b when in the connected state. In this manner, a particularly simple adjustment of the position along the edges of the cut-out 3 can be obtained.

A mounting system according to the invention contains at least one mounting device 1, and at least two receiving rails 4a, 4b. Alternatively, the mounting system can also include numerous mounting devices 1. This is useful in particular with very long receiving rails 4a, 4b, because with very long receiving rails 4a, 4b, there may be strong shearing forces exerted on the receiving elements 2a, 2b. A more stable, and especially a more torsion resistant, attachment of the receiving rails 4a, 4b can be obtained in this manner.

Alternatively, with a mounting system having just one mounting device 1 for installing the receiving rails 4a, 4b, it is possible to proceed such that the mounting device 1 is first attached to a common end of the two receiving rails 4a, 4b. The receiving rails 4a, 4b are then attached at these ends to the edges of the cut-out 3. The mounting device 1 is then slid along the length of the receiving rails 4a, 4b. This automatically results in a parallel and correct course of the receiving rails 4a, 4b. The receiving rails 4a, 4b can then be connected to the edges of the cut-out 3 at regular intervals. In this manner, very long receiving rails 4a, 4b can then be connected to the edges of the cut-out 3 as well. Very long receiving rails 4a, 4b can also be correctly installed in this manner, using just one mounting device 1.

The guide profiles 12a, 12b are preferably formed as an integral part of the frame 15 of the mounting device 1. They are preferably connected to one another by a connecting bridge on the side of the mounting device 1 facing away from the suspended wall or ceiling. As a result, a one-handed installation, and in particular a one-handed releasing and connecting of the receiving rails 4a, 4b from and to the mounting device 1 is enabled. In the exemplary embodiment depicted here, the connecting bridge is a part of the handle 14.

After installing the receiving rails 4a, 4b on the suspended ceiling or the suspended wall in the region of the cut-out 3, the mounting device 1 can be removed by releasing the receiving elements 2a, 2b. Subsequently, the receiving rails 4a, 4b can be plastered in along the plastering edges 8a, 8b. The task of the drywall hanger is then completed. A later refinishing after installation of the lamps is not necessary.

A side view of the mounting device 1 depicted in FIG. 1 is shown in FIG. 2. A top view of the mounting device 1 shown in FIG. 1 and FIG. 2 is depicted in FIG. 3.

The invention is not limited to the depicted exemplary embodiment. In particular, structural elements other than lamps can also be installed using the receiving elements. The use of more than one mounting device is also conceivable. In particular, it is also conceivable to deliver the receiving rails already connected to one or more mounting devices. All of the features described above or shown in the Figures can be advantageously combined with one another in an arbitrary manner within the scope of the invention.

1. A mounting device (1) for installing receiving rails (4a, 4b) for lamp housings to cut-outs (3) in suspended walls or ceilings, having
a substantially rigid frame (15), and connected thereto
a first receiving element (2a) for retaining a first receiving rail (4a), and
a second receiving element (2b) for retaining a second receiving rail (4b)
wherein the receiving elements (2a, 2b) are configured to retain the receiving rails (4a, 4b) parallel and at a defined spacing to one another, and the receiving rails (4a, 4b) are configured with a substantially L-shaped cross section, such that each receiving rail (4a,4b) has a first leg (5a, 5b) for mounting it to the undersurface of the suspended wall or a front surface of the suspended wall and a second leg (6a, 6b) for engaging in the cut-out (3) and for supporting the lamp housing, and further wherein the receiving elements (2a, 2b) are configured to retain the receiving rails (4a, 4b) such that the first legs (5a, 5b) run in a plane and the second legs (6a, 6b) are parallel.

2. The mounting device (1) according to claim 1, wherein the receiving elements (2a, 2b) are configured
to retain the receiving rails (4a, 4b) individually and/or collectively such that they can each be released, in particular such that they can be released with one hand, and/or
to retain the receiving rails (4a, 4b) such that they can each be displaced longitudinally in relation to the mounting device (1), and/or
to retain the receiving rails (4a, 4b) in a defined orientation to one another about their respective longitudinal axes.

3. (canceled)

4. The mounting device (1) according to claim 1 wherein the receiving elements (2a, 2b) each have a first guide profile (12a, 12b) for receiving a first profile (7a, 7b) of the second leg (6a, 6b) of the respective receiving rail (4a, 4b).

5. The mounting device according to claim 4 wherein the first guide profiles (12a, 12b) are flexible or resilient, and connected to the rigid frame (15) via resilient arms (16a, 16b, 17a, 17b).

6. The mounting device (1) according to claim 1 wherein the receiving elements (2a, 2b) each have a second guide profile (10a, 10b, 11a, 11b) for receiving a second profile (8a, 8b) of the respective receiving rail (4a, 4b) including a plastering edge (8a, 8b) of the respective receiving rails (4a, 4b).

7. The mounting device (1) according to claim 6 wherein the second guide profiles (10a, 10b, 11a, 11b) are rigid, provided as an integral part of the rigid frame (15) in wings extending laterally away from the frame (15), wherein the wings (18a, 18b) are flush with the first legs (5a, 5b) of the receiving rails (4a, 4b), when the receiving rails (4a, 4b) have been inserted.

8. The mounting device (1) according to claim 7 wherein the guide profiles (10a, 10b, 11a, 11b, 12a, 12b) serve as a guide, together with the corresponding elements (7a, 7b, 8a, 8b) on the part of the receiving rails (4a, 4b), for sliding the mounting device (1) longitudinally along the receiving rails (4a, 4b).

9. The mounting device (1) according to claim 8 wherein the first guide profiles (12a, 12b) are substantially opposite the second guide profiles (10a, 10b, 11a, 11b) and face one another, in order to be able to clamp the receiving rails (4a, 4b) between them by means of the guide profiles (10a, 10b, 11a, 11b, 12a, 12b).

10. The mounting device (1) according to claim 4 wherein the mounting device (1) also has a handle (14), which is connected to the rigid frame (15) via the first guide profiles (12a, 12b), by means of resilient legs (13a, 13b), and is used to hold the mounting device (1).

11. The mounting device (1) according to claim 1 wherein the receiving elements (2a, 2b) are each configured to simultaneously retain two longitudinally adjoining receiving rails (4a, 4b) aligned with one another.

12. The mounting device (1) according to claim 1 wherein the receiving elements (2a, 2b) are configured
to each receive a receiving rail (4a, 4b) not yet installed on the suspended ceiling or suspended wall, and
to receive a receiving rail (4a, 4b) already installed on the suspended ceiling or suspended wall, and a receiving rail (4a, 4b) not yet installed on the suspended ceiling or suspended wall.

13. The mounting device (1) according to claim 1 wherein the mounting device (1) has a single-piece design, and the mounting device (1) is produced as a stamped sheet metal or metal injection-molded part, or as a plastic injection-molded part.

14. A mounting system having a mounting device (1) according to claim 1, and at least two receiving rails (4a, 4b).

15. A mounting system having a first mounting device (1) according to claim 1 further comprising a second mounting device (1) and at least two receiving rails (4a, 4b), wherein the first mounting device (1) and the second mounting device (1) are configured to simultaneously retain the receiving rails (4a, 4b) at different positions of an end of the receiving rails (4a, 4b) and to be disposed such that each mounting device can be slid longitudinally along the receiving rails (4a, 4b).
